(19) United States
(12) Patent Application Publication
(10) Pub. No.: US 2010/0298009 A1
(43) Pub. Date: Nov. 25, 2010

(54) HANDS FREE MESSAGING

(75) Inventors: THOMAS C. DANTZLER, JR., COLORADO SPRINGS, CO (US); JARVIS A. WYATT, GREENWOOD VILLAGE, CO (US); RAOUL C. JOHNSON, COLORADO SPRINGS, CO (US); NICHOLIS V. BUFMACK, COLORADO SPRINGS, CO (US)

Correspondence Address: Law Office of Dorian Cartwright, P.O. Box 7617, San Jose, CA, 95150, US

(73) Assignee: AMAZING TECHNOLOGIES, LLC, COLORADO SPRINGS, CO (US)

(21) Appl. No.: 12/471,305

(22) Filed: May 22, 2009

(51) Int. Cl. H04W 4/12; G10L 15/26; H04M 1/00

(52) U.S. Cl. 455/466; 704/235; 455/550.1; 704/E15.043

(57) ABSTRACT

A method, system, and computer program product for hands-free messaging in a mobile computing device. A message from a local user is captured and converted to an outgoing text message by a speech recognition module. The outgoing text message is altered to conform with the boundary conditions of short message service (SMS), including a limitation on message length. SMS lingo is also substituted into the outgoing text message. After being verified by the local user, the outgoing text message is sent to a remote user of a mobile computering device. Incoming messages are also received from remote users.

### FIELD OF INVENTION

This invention generally relates to messaging applications, and, more specifically, to hands-free instant messaging with a mobile computing device.

### BACKGROUND OF THE INVENTION

Conventional instant messaging applications are operated from a personal computer (PC), sitting on a desktop, and connected to the Internet. The PC can have a full-sized keyboard that allows a local user to type easily messages to a remote user. Moreover, he Internet can transfer limitless amounts of data which allows the local user to input long messages.

Problematically, in a mobile environment, using a device such as a cell phone or a personal desktop assistant (PDA), a full-size keyboard may not be available. Furthermore, typing can be inconvenient and dangerous when driving or performing other activities. In addition, mobile devices may not have an Internet connection, but instead, use a data protocol such as short message service (SMS) to send instant messages. However, the SMS data protocol has limitations a on message sizes. More particularly, many SMS systems, which were originally designed for sending short control messages between a cell tower and a cellular telephone, limit a message size to 160 characters.

Another problem with messaging in a cell phone environment, is usage charges. Some service providers charge separately for SMS usage and Internet usage. Thus, excessive text messages can result in higher charges to a user.

Therefore, what is needed is a robust mobile computing device that provides a user with hands-free messaging services.

### BRIEF SUMMARY OF THE INVENTION

A method, system, and computer program product for hands-free messaging in a mobile computing device. A message from a local user is captured and converted to an outgoing text message by a speech recognition module. In one embodiment, the outgoing text message is altered to conform to the boundary conditions of short message service (SMS), including a limitation on message length. SMS lingo can be substituted into the outgoing text message. After being verified by the local user, in one embodiment, the outgoing text message is sent to a remote user of a mobile computering device. Incoming messages are also received from remote users.

For added security, security credentials of a local user can be presented in the form of a voice print. The voice print can be compared against a stored voice print prior to allowing a user to exchange messages. In one embodiment, an outgoing text message can be encrypted prior to being sent through a messaging module, on a selective basis (e.g., when sending text messages to a financial institution).

In still another embodiment, multiple data channels may be available for exchanging messages. Various algorithms can be implemented to select which channel should be used for a message. For example, one algorithm makes the selection based on current monthly usages of the data channel relative to a maximum allowed usage of a cell phone plan.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a block diagram illustrating a hands-free mobile messaging system, according to one embodiment of the present invention.

FIG. 2 is a block diagram illustrating a mobile computing device in further detail, according to one embodiment of the present invention.

FIG. 3 is a block diagram illustrating a message control module of in further detail, according to one embodiment of the present invention.

FIG. 4 is a flow chart illustrating a method of hands-free mobile messaging, according to one embodiment of the present invention.

FIG. 5 is a flow chart illustrating a method of two-way hands-free messaging, according to one embodiment of the present invention.

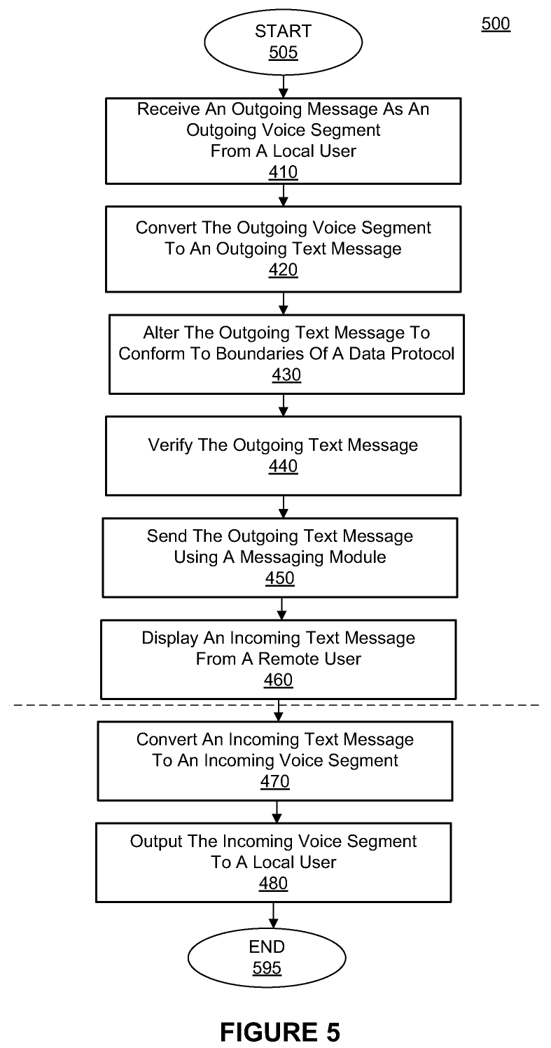

### DETAILED DESCRIPTION OF THE INVENTION

A method, system, and computer program product for hands-free messaging in a mobile computing device is disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

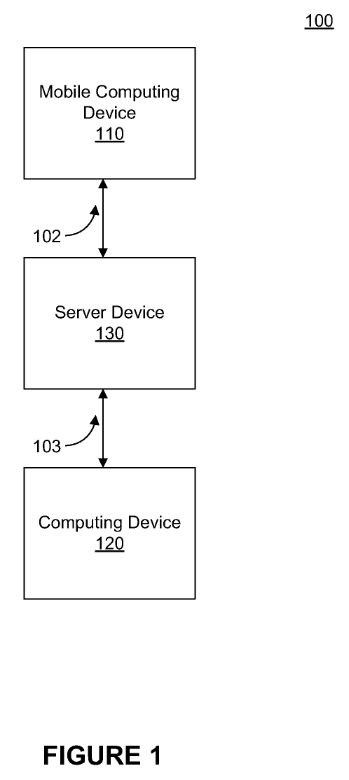

FIG. 1 is a block diagram illustrating a hands-free mobile messaging system 100 according to one embodiment of the present invention. The system comprises a mobile computing device 110, a computing device 120, and a server device 130. The system 100 is only an example implementation of the invention as variations can be made within the spirit of the invention. Another embodiment of the system 100 includes multiple computing devices in communication with the server device 130.

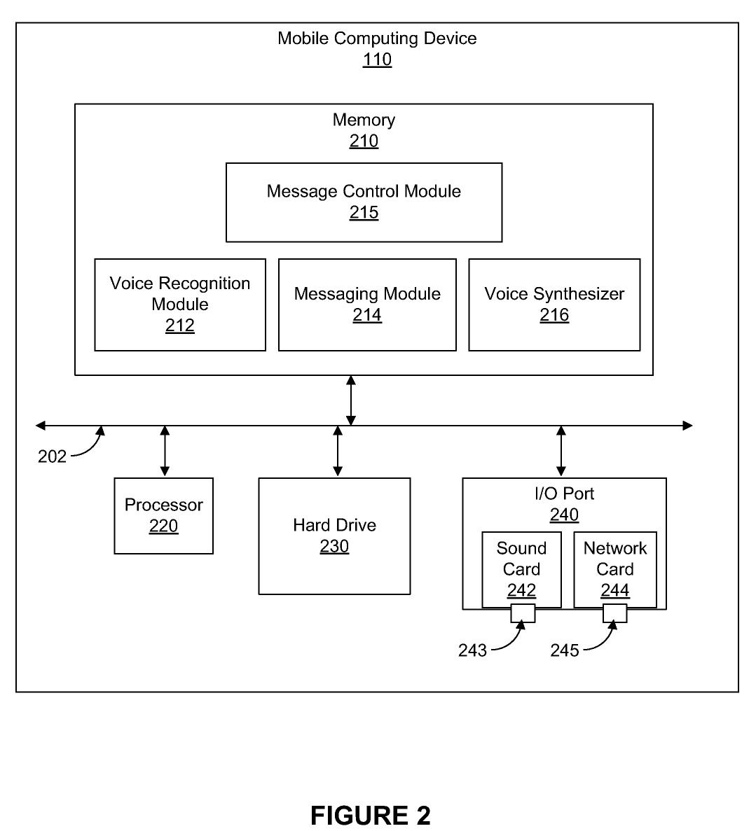

The mobile computing device 110 can be, for example, a cell phone, a smart phone (e.g., an iPhone® by Apple Computers, Inc. of Cupertino, Calif. or a BlackBerry®-type phone by Research In Motion Ltd. of Waterloo, Ontario), a personal desktop assistant (PDA), a laptop computer, a messaging device, or the like. The mobile computing device 110 is coupled in communication with a communications network via communications channel 102. The communications network can be a 3rd generation (3G) cellular network, 2nd generation GSM (2G) cellular network, the Internet, or a plain old telephone system (POTS). The connection can be wired or wireless, homogeneous or heterogeneous, and be a packet-based or dedicated connection. In one embodiment, the mobile computing device 110 provides a terminal for a user to input a voice segment which is output as a text message. A more detailed description of the mobile computing device 110 is set forth below in association with FIG. 2.

The computing device 120 can be, for example, a personal computer (PC), a stationary computing device, or any of the devices useable for the mobile computing device 110. The computing deice 120 is also coupled in communication with a communications network via communications channel 103. In one embodiment, the computing device 120 receives a text message sent by the mobile computing device 110.

The server device 130 can be, for example, a PC, a laptop, a server blade, or any other computing device. The server device 130 is coupled in communication with both the mobile computing device 110 and the computing device 120. In one embodiment the server device 130 manages the message routing between the mobile computing device 110 and the computing device 120, among other devices exchanging messages. In doing so, the server device 130 can interact with an SMS network components such as SMS gateways which provide a pathway for messages. In another embodiment, the server device 130 provides application-level connectivity between messengers executing on the mobile computing device 110 and the computing device 120.

The communications channels 102, 103 can be part of a homogeneous network of a single service provider, or part of a heterogeneous network in which messages travel between service providers. Furthermore, the communications channels 102, 103 can be a pure cellular network, a pure data network (e.g., the Internet), or a combination of different types of networks. For a cellular communications channel, cellular towers provide a link to a main switching center. Optionally, there can be multiple pathways of communication available between the server device and the computing device. For example, the components can be connected through both a cellular communications network and the Internet.

In one embodiment, the server device 130 offloads some of the functions described above in association with the mobile computing device 110. For example, a cell phone without much processing power can send a voice segment to the server device 130 for processing. As such, the server computing device 110 performs the voice recognition and interfacing with a messaging application. Alternatively, the cell phone can generate an outgoing text message that is further refined in the server device 130 (e.g., vocabulary of text message can be altered into SMS vocabulary as described below). Partially processed data can be sent from the mobile computing device 110 to the server device embedded in an extensible mark-up language (XML) document.

FIG. 2 is a block diagram illustrating a mobile computing device 110 of FIG. 1 in further detail according to one embodiment of the present invention. The mobile computing device 110 comprises a memory 210, processor 220, a hard drive 230, and an I/O port 240. The components of the mobile are coupled in communication via a bus 202. In some embodiments, other conventional computer components can be included such as an operating system (OS) (e.g., a mobile OS such as iPhone OS version 3.0, or a full features OS such as Linux or Microsoft Windows), drivers, a basic input/output system (BIOS), a motherboard, additional processors, and cooling devices. For example, in a smart phone implementation, the mobile computing device 110 can also include a keypad, an integrated display screen, and a subscriber identity module (SIM) card.

The memory 210 can be a random access memory (RAM), a flash memory, a non-persistent memory device, or any other device capable of storing program instructions being executed. The memory 210 further comprises a voice recognition module 212, a messaging module 214, a voice synthesizer 216 (optional), and a message control module 215. These components can communications can include software ports for inter-component communications and for communications with other aspects such as an OS.

The message control module 215 manages the overall messaging process. The message control module 215 can be invoked or terminated when the user touches an icon on a touch screen, or by some other technique. Once invoked, a daemon operates as a background process until messages are sent or received. A user interface allows a user to change settings, enter data, verify the output of speech recognition, and the like. In one embodiment, the message control module 215 responds to voice commands received from a user. In turn, the message control module 215 is able to invoke and terminate the voice recognition module 212, the messaging module 214 and/or the voice synthesizer 216 as needed. Moreover, data can be passed between components and even reformatted for compatibility. In some embodiments, the message control module 215 includes additional functionalities that are not provided in off the shelf modules. For example, an off the shelf voice recognition module 212 may not inherently provide verification of transcribed speech.

The voice recognition module 212 receives a voice segment from a user and converts the voice segment to text (e.g., XVoice, CVoiceControl, IBM VIaVoice, or CMU Sphinx). The messaging module 214 exchanges text messages between users subscribed to a common service provider. The voice synthesizer 216 can include a phonetic library to convert text to speech that is audible to a local user. The messaging module 214 send and receives messages using a data protocol such as short messaging service (SMS), multimedia messaging service (MMS), enhanced messaging service (EMS), J-Phone messaging, or any other data protocol suitable for user messages. Although SMS is used as an exemplary implementation herein, it will be understood that any data protocol can be substituted. In one implementation, the messaging module 214 can be an instant messaging client. In another implementation, the messaging module 214 can be a text messaging module (e.g., an SMS application) or e-mail module is provided to exchange messages.

In one embodiment, the components can be seamlessly integrated and made available from a single source. In another embodiment, the components can be provided by various sources, and be made compatible using application program interfaces (APIs). For example, the voice recognition module 212 can be included as part of a native application of the mobile computing device 110 (e.g., integrated with an OS), while the messaging module 214 is downloaded from an online service provider (e.g., America Online IM, Yahoo IM, Facebook IM or a client that combines several IMs).

The processor 220 can be a general purpose processor, an application-specific integrated circuit (ASIC), a field programmable gate array (FPGA), a reduced instruction set controller (RISC) processor, an integrated circuit, or the like. There can be a single core, multiple cores, or more than one processor. In one embodiment, the processor 220 is specially suited for the processing demands of hands-free messaging (e.g., custom micro-code, instruction fetching, pipelining or cache sizes). The processor 220 can be disposed on silicon or any other suitable material. The processor 210 can receive and execute instructions and data stored in the memory 210 or the hard drive 230.

The hard drive 230 can be a platter-based storage device, a flash drive, an external drive, a persistent memory device, or any other type of memory. In some embodiments, the hard drive 230 can be coupled to the mobile computing device 210 through a network. The hard drive 230 provides persistent (i.e., long term) storage for instructions and data.

The I/O port 240 is an input/output panel including a sound card 242 and a network card 244. The sound card 242 includes an interface 243 for inputs such as a microphone jack or outputs such as a speaker jack. The sound card can further include audio processing capabilities such as an audio-to-digital converter (e.g., 8 or 16-bit) and a digital-to-analog converter for converting incoming and outgoing voice segments. Additional processing by the sound card 242 can include noise reduction and other types of filtering. In an alternative embodiment, interface 243 includes a Bluetooth transceiver for wirelessly exchanging digital data with a Bluetooth headset which includes a microphone and a headphone. The network card 244 can be, for example, a wireless networking card (e.g., an IEEE 802.11 card, or an IEEE 802.3 card), a cellular networking card (e.g., a 3G card). An interface 245 is configured according to the types of networking compatibility. The network card 244 provides access to a communications network.

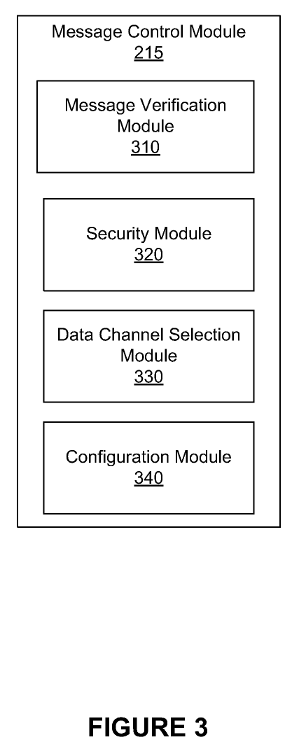

FIG. 3 is a block diagram illustrating a more detailed view of the message control module 215 of FIG. 2 according to one embodiment of the present invention. The message control module 215 comprises a message verification module 310, a security module 320, a data channel selection module 330, and a configuration module 340. The example of FIG. 3 can be implemented with fewer than all of the shown components, or with additional components, and still be within the spirit of the present invention.

The message verification module 310 provides a feedback to a local user to ensure that an outgoing text message has been accurately transcribed. For example, once an outgoing voice segment has been converted to an outgoing text message, the message verification module 310 can delay sending the outgoing text message until confirmed by the local user. In one implementation, the message verification module 310 can synthesize the outgoing text message to a voice segment that is output to the user for confirmation.

The security module 320 provides various aspects of protection to a local user. For example, the security module 320 can sign-on the local user responsive to a user name and password credentials. The sign-on can be voice activated. More specifically, a voice print from the local user speaking a password can be compared to a stored voice print. In addition, the security module 320 can encrypt an outgoing text message prior to being sent to the messaging module 214 of FIG. 2, or prior to being sent across a communications network. If the message is encrypted for a messaging module 214, a remote message control module can perform decryption after being received by a remote messaging module. In one embodiment, the security module can selectively provide enhanced security based on the type of message being sent. For example, if the local user is performing a banking or other financial transaction using hands-free messaging, the security module 320 can encrypt an associated outgoing text message. Furthermore, an incoming text message can be output to the user, but redacted from persistent storage, or require a password to be viewed at a later time.

The data channel selection module 330 selects which data channel will be used to transmit outgoing text messages when more than one is available. For example, a mobile computing device 110 of FIG. 1 can be connected to an SMS data channel and to the Internet. Some cell phone plans charge according to a number of SMS messages or to an amount of data sent or received over the Internet. Moreover, one channel may be temporarily unavailable, have poor performance, or not have sufficient security. A variety of algorithms can be implemented to automatically select the data channel. Also, a local user can manually configure which data channel to use.

The configuration module 340 provides automatic and manual settings for operation of hands-free messaging. Examples of configurations include display options, voice options, choice of instant messaging client, password and username management, configuration of SMS lingo, data channel selection, security selection, message verification options, and the like.

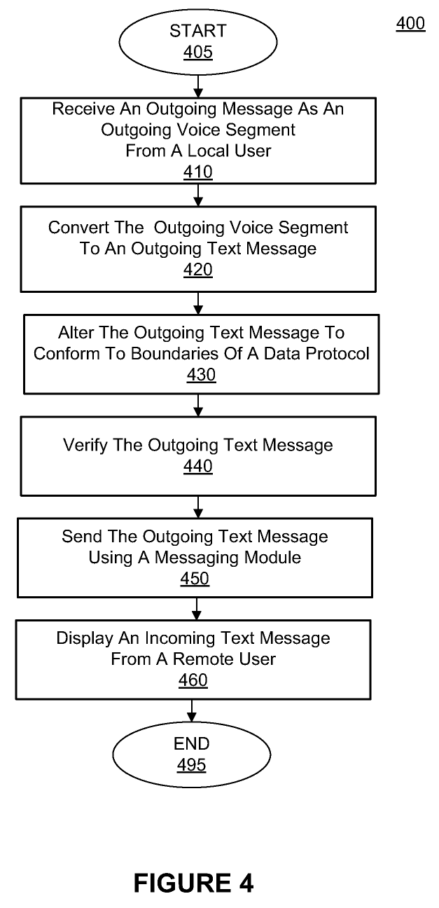

FIG. 4 is a flow chart illustrating a method 400 of hands-free mobile messaging according to one embodiment of the present invention. The method 400 can be implemented in a computer system such as the system 100 described in association with FIGS. 1-3 above. The method 400 can be invoked 405 automatically at power-up or manually by a local user. In one embodiment, security credentials are verified (e.g., by the security module 320) prior to allowing access.

An outgoing message is received 410 as a voice segment from a local user (e.g., by the sound card 242). The voice segment is digitized, or captured, from a natural voice (i.e., analog). The digitization can be varied in quality (e.g., sampling rate of 8 to 28 kHz or higher). In one embodiment, digitization quality is varied in accordance with total processing power of a device, or currently available processing power due to other tasks.

The voice segment is converted 420 to text (e.g., by the voice recognition module 212). One technique of conversion uses pattern recognition. In doing so, the voice segment is separated into utterances (i.e., isolated words, partial words, or continuous words), pre-filtered, filtered, and framed and windowed. The results are compared against a vocabulary using known or trained patterns. Known patterns are generic to a user while trained patterns are set for a particular user.

As needed, the outgoing text is altered 430 to conform to boundaries of a data protocol. One example boundary is the 160-character limit of many SMS systems. Because of the size limitation, SMS messages sent from a basic SMS messaging application may not fit within the limitation. The outgoing text is tested to determine whether the SMS boundary has been exceeded. If so, the words and/or phrases of the text are matched against an abbreviation vocabulary. The abbreviations represent a similar substance to the original word or phrase using fewer characters. For example, the phrase “talk to you later” can be abbreviated with “TTYL”; the word “for” can be abbreviated with “4”; the phrase “good morning” can be abbreviated with “GM”; and the word “between” can be abbreviated with “b/w”. The abbreviation library can contain hundreds or thousands of abbreviations which can be updated with an online update, or by manual entries from a local user. In another embodiment, the abbreviation vocabulary is automatically applied, regardless of whether a boundary condition is exceeded. In this example, the alterations are aesthetic rather than functional.

Another way to meet the boundary condition is to concatenate the outgoing text into several portions. Each portion is then separately processed through the remaining steps. When received by the remote user, the portions can either be displayed as separate text messages or combined back together into a single text message. A flag can be set to notify the receiving instant messaging module that a text message has been separated.

In an optional step, the outgoing text is verified 440 (e.g., by the message verification module 310) prior to being sent. An outgoing text is displayed to a local user for review. In one implementation with an application user interface, an optional pop-up window can ask the local user whether the message needs editing. A display window allows manual editing of the outgoing text via a keyboard or keypad. Otherwise, the outgoing message is accepted. In one implementation, the outgoing message is converted to a voice segment by a speech synthesizer and read back to the local user. A verbal command can indicate whether the message is acceptable for delivery or whether further editing is needed.

Next, the outgoing text is sent 450 using a messaging module (e.g., by the messaging module 214). Whether or not the outgoing text is altered, a messaging service that has set up a communication path between a local user and a remote user passes the text across a network. In another optional step, the outgoing text message is encrypted (e.g., by the security module 320), prior to being sent to the messaging module. A reciprocal decrypting step is provided when an encrypted message is received from an instant messaging module. In still another optional step, a data channel can be selected (e.g., by the data channel selection module 330) in accordance with various algorithms or manually by a user. For example, if a user has reached a threshold of SMS messages during a monthly billing period, but has unlimited Internet usage, the outgoing text message can be sent over the Internet until a new billing period.

An incoming text message is received 460 from a remote user and displayed to a local user (e.g., by the messaging module 214). The incoming text message can be displayed as a thread, or as a discrete message.

FIG. 4 is a flow chart illustrating a method 500 of two-way hands-free messaging according to one embodiment of the present invention. Compared to the one-way voice path of FIG. 3, in one implementation, steps 410, 420, 40, 440, 450 and 460 can be similar.

By contrast, the two-way voice path includes additional steps. More specifically, the incoming message is converted 470 from an incoming text message to a voice segment (e.g., by the voice synthesizer 216). The incoming message is pre-processed, or normalized, to convert raw text containing SMS lingo, symbols, numbers and the like into the equivalent of written out words. Phonetic transcriptions are then assigned to each word.

The voice segment is output 480 to a local user (e.g., by the sound card 242). In one embodiment, a notification is first sent to the local user before outputting. This allows the user to delay output until convenient.

Computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

An OS for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A computer-implemented method comprising:
detecting a message from a local user as an outgoing voice segment in a mobile computing device;
invoking a text recognition module to convert the outgoing voice segment to an outgoing text message; and
invoking an instant messaging module to send the outgoing text message to a remote user.

2. The method of claim 1, wherein the text recognition module and the instant messaging module are separate applications that are not inherently compatible.

3. The method of claim 1, wherein the instant messaging module comprises one selected from the group consisting of America Online IM, Yahoo IM, and Facebook IM.

4. The method of claim 1, further comprising:
altering content of the outgoing text message to conform to boundary conditions associated with the data protocol.

5. The method of claim 4, wherein altering comprises abbreviating the outgoing text message to confirm to a message length limitation associated with short message service (SMS) protocol.

6. The method of claim 4, wherein altering comprises substituting words or phrases with lingo provided in an SMS lingo database.

7. The method of claim 1, further comprising:
prior to sending, displaying the outgoing text message for verification.

8. The method of claim 1, further comprising:
displaying an incoming text message from a remote user.

9. The method of claim 1, further comprising:
converting an incoming message to an incoming voice segment.

10. The method of claim 9, further comprising:
outputting the incoming voice segment to the local user.

11. The method of claim 1, further comprising:
receiving security credentials from the local user as a voice print;
comparing the voice print against a stored voice print; and
allowing access to the instant messaging module responsive to the voice print matching the stored voice print.

12. The method of claim 1, further comprising:
detecting that a plurality of data channels are available to send the outgoing text message; and
automatically selecting one of the plurality of data channels to send the outgoing text message based on current usage parameters and billing parameters associated with the plurality data channels.

13. A computer readable medium encoded with computer program instructions, the computer program comprising computer-executable code for:
detecting a message from a local user as an outgoing voice segment in a mobile computing device;
invoking a text recognition module to convert the outgoing voice segment to an outgoing text message; and
invoking an instant messaging module to send the outgoing text message to a remote user.

14. The computer readable medium of claim 13, wherein the text recognition module and the instant messaging module are separate applications that are not inherently compatible.

15. The computer readable medium of claim 13, wherein the instant messaging module comprises one selected from the group consisting of American Online IM, Yahoo IM, and Facebook IM.

16. The computer readable medium of claim 13, further comprising:
altering content of the outgoing text message to conform to boundary conditions associated with the data protocol.

17. The computer readable medium of claim 16, wherein altering comprises abbreviating the outgoing text message to confirm to a message length limitation associated with short message service (SMS) protocol.

18. The computer readable medium of claim 16, wherein altering comprises substituting words or phrases with lingo provided in an SMS lingo database.

19. The computer readable medium of claim 13, further comprising:
prior to sending, displaying the outgoing text message for verification.

20. The computer readable medium of claim 13, further comprising:
displaying an incoming text message from a remote user.

21. The computer readable medium of claim 13, further comprising:
converting an incoming message to an incoming voice segment.

22. The computer readable medium of claim 21, further comprising:
outputting the incoming voice segment to the local user.

23. A mobile computer device, comprising:
a control module to detect a message from a local user as an outgoing voice segment in a mobile computing device;
a text recognition module, coupled in communication to the control module, the text recognition module invoked by the control module to convert the outgoing voice segment to an outgoing text message; and
an instant messaging module, coupled in communication to the control module, the instant messaging module invoked by the control module to send the outgoing text message to a remote user.

24. The mobile computer device of claim 23, wherein the text recognition module and the instant messaging module are separate applications that are not inherently compatible.

25. The mobile computer device of claim 23, further comprising:
altering content of the outgoing text message to conform to boundary conditions associated with the data protocol.

26. The mobile computer device of claim 25, wherein altering comprises abbreviating the outgoing text message to confirm to a message length limitation associated with short message service (SMS) protocol.

27. The mobile computer device of claim 25, wherein altering comprises substituting words or phrases with lingo provided in an SMS lingo database.

28. The mobile computer device of claim 23, wherein the mobile computing device comprises a smart phone.

29. The mobile computer device of claim 21, wherein the outgoing text message is sent to a remote user of a smart phone.
